(19) United States
(12) Patent Application Publication
(10) Pub. No.: US 2004/0194584 A1
(43) Pub. Date: Oct. 7, 2004

(54) Electrically insulated hand tool with a detent mechanism

(76) Inventor: Tone Ofentavsek, Slovenske Konjice (SI)

Correspondence Address: ABELMAN, FRAYNE & SCHWAB, 150 EAST 42ND STREET, NEW YORK, NY, 10017-5612, US

(21) Appl. No.: 10/832,513

(22) Filed: Apr. 26, 2004

Related U.S. Application Data
(63) Continuation-in-part of application No. 09/958,217, filed on Dec. 13, 2001, now abandoned.
Application No. 09/958,217 is a 371 of international application No. PCT/SI00/00006, filed on Apr. 5, 2000.

(30) Foreign Application Priority Data
Apr. 6, 1999 (SI) P-9900079

(51) Int. Cl. B25B 13/00

(52) U.S. Cl. 81/54

(57) ABSTRACT

An electrically insulated hand tool with a detent mechanism allows for rotation and/or for the transfer of force in a specific direction only, with the direction of rotation and/or the direction of the transfer of force is determined through two pushbuttons. The electrically insulated hand tool with a detent mechanism includes, in the body of the tool, a top closed by an upper sheet metal cover, and from below, by a lower sheet metal cover, and a switching mechanism controlled by two switching pushbuttons which are covered with a soft membrane, with the whole tool being covered with an insulating coating.

### CROSS-REFERENCE TO RELATED APPLICATIONS

This application is a continuation-in-part of co-pending U.S. application Ser. No. 09/958,217, filed Dec. 13, 2001, which is a 371 of PCT/SI00/00006, filed Apr. 5, 2000.

### BACKGROUND OF THE INVENTION

1. Field of the Invention

The invention refers to electrically insulated hand tools with a detent mechanism that allows for rotation and/or for the transfer of force in a specific direction only, whereby the direction of rotation and/or the direction of the transfer of force can be determined through two pushbuttons. The tool is used in combination with attachments of different size, provided for tightening and/or loosening of nuts and/or screws with duly shaped heads. The invention is classified in class B 25B of the international patent classification.

2. Description of the Related Art

The technical problem successfully solved by this invention involves such design and construction of the electrically insulated hand tool that will enable efficient insulation and easy switching of the direction of rotation.

With the existing designs of this type of tool in the prior art, the problem of insulation of the hand tool with a detent mechanism has been solved through plastification of the standard tool and in particular of the respective handle and individual attachments. Such a solution has been described in the patent document No. EP0331534. The deficiencies of such solution are primarily manifested in the fact that, in case of the need for any repair, such tool cannot be disassembled or repaired, but must be replaced by a new one; besides, the knob provided for regulation of the direction of rotation is not insulated.

The patent document EP0432278 describes a prior art hand tool with a detent mechanism that allows for switching of the direction of rotation by means of a sliding knob on the handle. The sliding knob is connected with a locking rail that can be moved into one or other direction in order to move the tool into one direction or other. In this case, the sliding knob is not a perfectly reliable design solution, because in case of an accidental depression of the knob, the locking rail may move, whereby in case of a strong force the teeth of the gear currently being gripped may get damaged.

Each of the above described versions of the hand tool in the prior art with a detent mechanism solves a specific technical problem, while the present solution in question and described herein aims at the manufacture of such an electrically insulated hand tool with a detent mechanism whereof the presently disclosed design will provide for reliable electrical insulation of the tool, while the switching of the direction of rotation will be simple and possible with only the tool holding hand.

### BRIEF SUMMARY OF THE INVENTION

The electrically insulated hand tool with a detent mechanism referred to in this invention consists of a tool body, from the top and from the bottom closed by sheet metal covers, bearing a switching mechanism controlled by two switching pushbuttons that are covered with a soft membrane. The whole tool is covered with an insulating coating that provides for good electrical insulation of the tool from the user.

The present invention is related to commonly-assigned and co-pending U.S. application Ser. No. 09/958,217, filed Dec. 13, 2001, which is incorporated herein by reference.

### BRIEF DESCRIPTION OF THE SEVERAL VIEWS OF THE DRAWINGS

The invention will be described in detail by means of concrete examples and the corresponding figures where:

FIG. 1 shows the electrically insulated hand tool with a detent mechanism referred to in this invention, in a top cross-sectional view;

FIG. 2 shows the electrically insulated hand tool with a detent mechanism referred to in this invention, in a top plan view; and

FIG. 3 shows the electrically insulated hand tool with a detent mechanism referred to in this invention, in a lateral cross-sectional view.

### DETAILED DESCRIPTION OF THE INVENTION

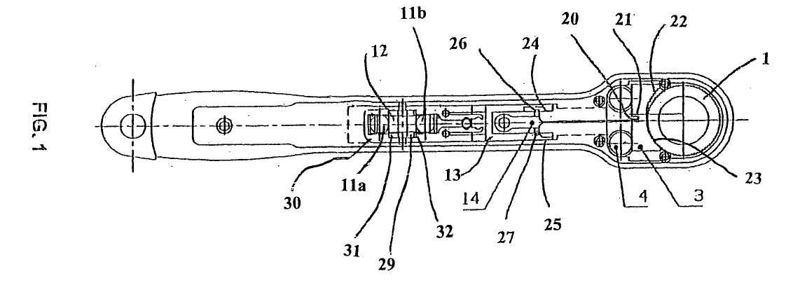

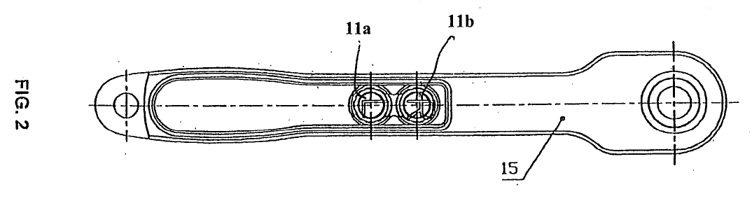

As a matter of fact, the electrically insulated hand tool with a detent mechanism, such as referred to in this invention and shown in FIGS. 1 through 3, essentially consists of the body 8 of the tool, from the top closed by the upper sheet metal cover 5 and from below by the lower sheet metal cover 6. Both covers 5, 6 are fixed to the body 8 by two screws 18, 19. On a proximal end of the tool, there are the upper handle 9 and the lower handle 10, while on the distal end of the tool the gear 1 is mounted perpendicularly to the longitudinal axis of the body 8. Through the gear 1, there runs the opening axle 2 that acts through the spring 16 to the ball 17. Upon depression of the top of the opening axle 2, the axle 2 moves in such a way that the ball 17 disappears into the opening on the axle 2. In this way, it is easy to replace the attachable tools, but in the initial position of the opening axle 2, the attachable tool cannot fall out due to the disappearing ball 17.

Approximately in the center of the tool referred to in this invention, the body 8 bears the mechanism for switching the direction of rotation. It consists of the pendulum 12, the switch member 13, and the spring member 14 operating a detent 3 movable between two lateral end positions substantially adjacent to the gear 1. The pendulum 12 is capable of pivoting about a fixed pivot axis within the body 8. The switch member 13 and the spring member 14 are capable of sliding movement in the longitudinal direction within the body 8 of the tool.

On the upper side of the tool, there are two switching pushbuttons 11 that actuate the pendulum 12 to pivot and rotate about the pivot axis. The base 28 of the pendulum 12 is positioned within a slot 29 at a proximal end 30 of the switch member 13.

The pendulum 12, depending on which of the switching pushbuttons 11a, 11b is depressed, pivots and rotates to move the base 28 thereof at least longitudinally within the slot 29 at the proximal end 30 of the switch member 13.

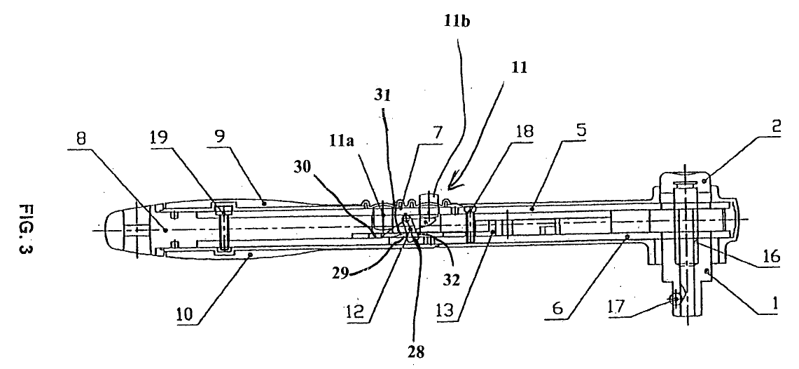

The slot 29 has two engagement surfaces 31, 32, at a proximal end and at a distal end of the slot 29, respectively. When a proximal switching pushbutton 11 a is pressed downward, the pendulum 12 rotates counterclockwise with respect to the view in FIG. 3, causing the base 28 to move at least distally to engage and push distally and longitudinally the distal engagement surface 32. On the other hand, when a distal switching pushbutton 11b is pressed downward, the pendulum 12 rotates clockwise with respect to the view in FIG. 3, causing the base 28 to move at least proximally to engage and push proximally and longitudinally the proximal engagement surface 31.

Accordingly, downward pushbutton movement of the pushbuttons 11a, 11b is translated into longitudinal movement of the switch member 13, distally or proximally, respectively. Such longitudinal movement of the switch member 13 moves curved surfaces 24, 25 at the end of the switch member 13 in the longitudinal direction to respectively engage the arms 26, 27 of the spring member 14, respectively, to engage and laterally move the free end 20 of the spring member 14.

Referring to FIG. 1, when the switch member 13 moves distally due to the counterclockwise rotation of the pendulum 12 and the resulting at least longitudinal and distal movement of the base 28, the curved surface 25 of the switch member 13 moves the arm 27 upward with respect to the orientation and view of FIG. 1, causing the spring member 14 to move the free end 20 upwardly. On the other hand, when the switch member 13 moves proximally due to the clockwise rotation of the pendulum 12 and the resulting at least longitudinal and proximal movement of the base 28, the curved surface 24 of the switch member 13 moves the arm 26 downward with respect to the orientation and view of FIG. 1, causing the spring member 14 to move the free end 20 downwardly.

The free end 20 of the spring member 14 engages a slot 21 in the detent 3, such that the resulting lateral movement, upwardly or downwardly, of the free end 20 by lateral movement of the spring member 14 causes lateral movement of the detent 3 that is not fixed anywhere to be moved between the two lateral end positions, with one of the pair 22, 23 of sets of teeth of the detent 3 being in the grip of the gear 1. Longitudinal shifting of the detent 3 is prevented by the supports 4. Upon depression of the first switching pushbutton 11a, the force is transferred to the pendulum 12 that starts rotating and actuates the switch member 13 to move the switch member 13 longitudinally and distally. This involves a change to the support of the switching spring member 14, due to engagement of the curved surfaces 24, 25 at the end of the switch member 13 with the arms 26, 27, respectively, to laterally move the free end 20 of the spring member 14 to cause the placement of the detent 3 into one of the end positions. Upon depression of the second pushbutton 11b, the pendulum 12 rotates backwards and the switching is effected in the opposite direction.

The detent 3 is constructed in such a way that the load of the gear 1 drags the detent 3 in the direction of the end position, while the force is transferred to the support. When the gear 1 is rotated into the opposite direction, the detent 3 moves away from the end position, which allows for a reverse stroke. The detent 3 is pushed back into the end position by the switching spring member 14. As a matter of fact, in the end position the detent 3 is gripping several teeth, which allows for transmission of even bigger moments.

Both switching pushbuttons 11 are covered with a soft membrane 7 and the whole body 8 of the tool is covered with an insulating coating 15. The insulating coating 15 is produced through injection molding of the tool during assembly. The handle of the tool is of a general anatomical shape and manufactured in combination with a soft material. The body 8 is made of plastic, reinforced with the upper sheet metal cover 5 and with the lower sheet metal cover 6.

What is claimed is:

1. An electrically insulated hand tool with a detent mechanism comprising:
a body (8) of the tool, from the top closed by an upper sheet metal cover (5) and from below by a lower sheet metal cover (6), which contains a switching mechanism controlled by two switching pushbuttons (11) that are covered with a soft membrane (7), with the whole tool being covered with an insulating coating (15);
wherein the switching mechanism includes:
a pendulum (12) which pivots when actuated by a user pressing one of the two switching pushbuttons (11);
a switch member (13) which is moved longitudinally by the pendulum (12);
a spring member (14) having arms which engage curved surfaces of the switch member (13), wherein the longitudinal movement of the switch member (13) causes lateral movement of a free end (20) of the spring member (14); and
a detent (3) having a slot (21) engaging the free end (20) of the spring member (14), wherein the lateral movement of the free end (20) laterally moves the detent (3) to one of a pair of end positions to partially lie in the grip of a gear (1) of the tool, thereby controlling the direction of rotation of the gear (1) during use of the tool.

2. The insulated hand tool with a detent mechanism according to claim 1, wherein each of the two switching pushbuttons (11) corresponds to a respective direction of rotation of the gear (1).

3. The electrically insulated hand tool with a detent mechanism according to claim 1, wherein the body (8) is composed of plastic.

4. The electrically insulated hand tool with a detent mechanism according to claim 2, wherein the body (8) is composed of plastic.
